(19) United States
(12) Patent Application Publication
(10) Pub. No.: US 2014/0214843 A1
(43) Pub. Date: Jul. 31, 2014

(54) Method For Chronicling Legacy Using Social Networks

(71) Applicant: Dana Marie Arvig, Salinas, CA (US)

(72) Inventor: Dana Marie Arvig, Salinas, CA (US)

(21) Appl. No.: 13/752,347

(22) Filed: Jan. 28, 2013

(51) Int. Cl. G06F 17/30

(52) U.S. Cl. CPC G06F 17/30598
USPC 707/740

(57) ABSTRACT

Disclosed herein is a social networking system aimed at creating a reviewable legacy for users. The described social network allows subscribers and public users to contribute events that previously occurred and discuss the significance of these events to themselves and others. Through the use of a plurality of subscribers and the public alike, the contributed events to the social network will create a searchable history of society. Additionally, the submitted events will include the impressions of the people who experienced them providing a zeitgeist record uncontaminated by subsequent historical impressions.

### FIELD OF THE INVENTION

The present invention relates to the field of social media. More particularly, the present invention relates to creating a searchable database of events, which are internally tagged and categorized.

### BACKGROUND OF THE INVENTION

Presently social media and the Internet allow users to chronicle daily activities. This chronicling is accomplished in several different ways. For example, Facebook approaches this process through “status updates.” Status updates are placed on a user's “timeline” and are viewable directly, or in the aggregate, on the Facebook “newsfeed.” These updates range in importance from daily minutia to the birth of children. Users are unable to flag statuses for content; however, Facebook operates in such a manner that it will recognize commonalities between status updates, and group like statuses together in the “newsfeed.” For example, if ten “friends” of a given user are posting statuses about a particular baseball game, those status updates will be condensed together.

Twitter, another popular social media service, does allow a user to flag posts by categories with “hashtags.” These tags and the rate particular tags are used are tabulated and represented to the public to show which tags were popular at any given point in time.

These services social networking, and others, do not provide a way for users to actively flag events, and then allow the service to compile the tagged events into a viewable, searchable history.
An article entitled, “A Final Act: Writing Your Own Obituary” by Grade Bonds Staples appeared in the Nov. 4, 2012 issue of the Atlanta Journal-Constitution. This article discussed the desire of people to be able to either ensure that enough about their lives was known that their loved ones could adequately eulogize them or that they would be able to do it themselves. While this article discussed a product which aided purchasers in writing a complete obituary, it does not completely fulfill the need of certain people to adequately leave their mark or legacy on the world after they are gone.

Accordingly, there is a need for a system that can effectively chronicle a presentable history, in point of fact, a legacy which users can search for content. The present invention provides a method of chronicling personal legacy, so as to allow a broader history to be ascertained.

### SUMMARY OF THE INVENTION

It is an object of the present invention to provide a social networking system that develops a searchable history of society through participation of subscribers and the public alike.

It is an additional object of this invention to provide, on a personal level, the ability to leave a legacy of one's life.

To achieve the objects of the invention described above and those that will be understood hereafter, the social network is a method for chronicling personal data over a social network using a database having users comprising: storing in a database a user profile for a user of a social network system, the user profile viewable by a social network user interface; entering event data into the social network user interface, the event data including information about an event in the life of a user and having at least one criteria flag, wherein the at least one criteria flag is a detail pertaining to the event; cataloging entered event data into the database, organized by criteria flag; searching the database for event data using at least one criteria flag as a search term; and displaying search results on the social network user interface.

In an exemplary embodiment of the system of the present invention, a private and secure database is established. Subscribers to the system establish submission accounts on the system's general database using the Internet. The system's subscribers log into their accounts and contribute to the general database. These contributions comprise events of relevance or importance to the subscriber's life. The events entered in the database are tagged and sorted by various criteria. Criteria for an event includes location, time, activity, participants as well as any suitable criteria determined by the software and user parameters. For example, as subscribers enter more and more data, they build their own (and other's) life story and a historical timeline. Entry points include such things as people that have impacted their lives, favorite books, important music, and significant movies. Obviously, there are too many different categories to mention. Basically, a subscriber enters what is impactful in their lives. From this data, a subscriber constructs his/her own obituary (or “faux-bituary”).

These criteria are run through a “truth engine” where the system determines by comparison, if submissions are incorrect. For example, if a plurality of unrelated subscribers submit data events stating a certain conference occurred on a particular date in Houston, Tex., the system recognizes such a data event as most likely a true statement. A discrepancy flag occurs when a subscriber claims to have attended the same conference, but in Buffalo, NY. This discrepancy event shares at least one criteria flag with a plurality of others, however it that disagrees with the majority on a separate criteria flag. Such a discrepancy event would be considered an outlier. The outliers may be outright rejected, corrected, or taken into account when determining the system's certainty of the facts of a given event. Depending on the particular software engine, a statistical confidence interval may be derived and the appropriate action taken.

Additionally, subscribers can contribute impressions of a given event. These impressions can simply be stored and presented in catalog fashion. Alternatively, the impressions may be collated, such that the system may construct a summary of the event. For example, were a plurality of subscribers to mention attending a particular summer camp, and the impression mentioned the effect of a particular camp counselor on the subscriber's lives, the collated summary would include a description of that counselor and the positive, or negative affects the counselor had on others.

This data is then presented to subscribers in multiple ways. In one preferred embodiment a user views a personal profile of all the events that subscriber submitted. Additionally, a subscriber can view events that particular subscriber was mentioned in, or collated event summaries in which the subscriber was mentioned. In a second preferred embodiment, subscribers can search by criteria associated with particular events in order to find other matching criteria. For example, were a subscriber wanting to know participants at a summer camp, in a given location on a given date, the system could allow searches of that nature which would reveal subscribers who had submitted events matching the search criteria.

Different ranks or classes for subscribers may also be established to allow greater or weaker searching ability. Additionally privacy features would exist wherein subscriber submitted events would be shielded from search at varying degrees.

It is an advantage of the present invention to provide a crowd sourced history logging method which can readily be searched. It is further an advantage of the present invention to automatically check for historical discrepancies created by the “crowd.”

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a preferred embodiment of a social networking system.

FIG. 2 is a flow chart illustrating submission of data by a registered subscriber to the central database.

FIG. 3 is a flow chart illustrating the receipt of data on the central database.

FIG. 4 is an example of a social networking user profile and interface.

FIG. 5 is an illustration of a particular event contained within the central database.

FIG. 6 is a flow chart illustrating the search capabilities of the social networking system.

### DETAILED DESCRIPTION OF THE INVENTION

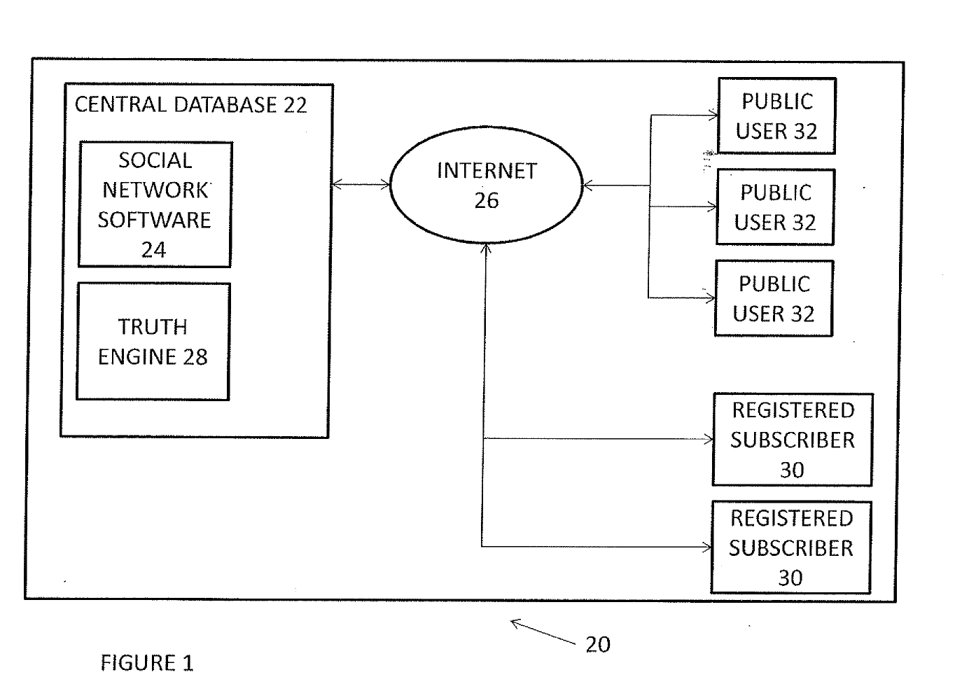

The invention will now be described with respect to FIG. 1. FIG. 1 is a preferred embodiment of a social networking system generally denoted by the numeral 20. The system includes a central database which is denoted by numeral 22. The central database stores the data of the social network 20 in accordance with this invention. Internal to this central database 22 is social networking software 24 which is used to process the data submitted to the network, and present that data in a preferred manner over the internet 26. Additionally, in the exemplary embodiment shown in FIG. 1, the central database 22 includes a truth engine 28 which compares and verifies data submitted against itself. When reviewing multiple sources of data, the truth engine 28 detects outliers and rejects, corrects, or takes the outliers into account when determining the system's certainty of the facts of comparable data.

The social networking software 24 allows others to communicate with the central database over the Internet 26 using suitable Internet browsers known in the art. The interface presented to others would differ depending on whether the outsider was a registered subscriber 30 or anyone in the public 32. As a registered subscriber 30, one creates a user profile on the central database 22. Both classes of users 30, 32 are able to submit data to the central database 22. While both registered subscribers 30 and public users 32 may search the central database 22, the extent to which each can do so may differ. Other differences between registered subscribers 30 and public users 32 will be covered in greater detail below.

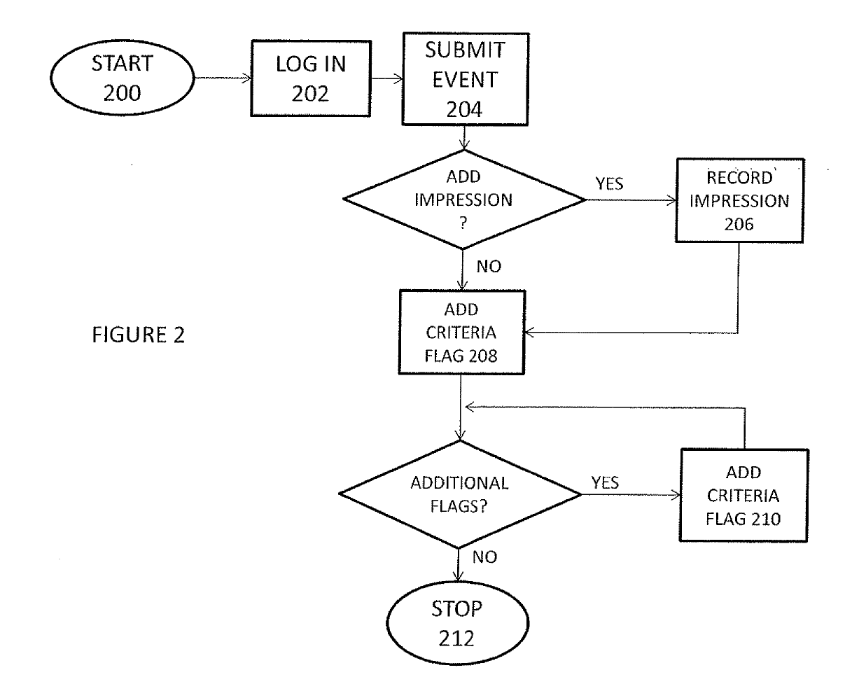

With particular reference to FIG. 2, there is shown a flow chart illustrating submission of data by a registered subscriber to the central database 22. Using a web browser, the subscriber logs into their account 202. This involves the entering of account information such as a user name and/or a password or other suitable means known in the art. Once logged in, the registered subscriber 30 contributes data to the central database 22. These contributions comprise events of relevance or importance to that subscriber or another person the subscriber knows 204. The subscriber may optionally record their impressions of the event 206. This could include a summary, how the subscriber felt during the event, what the event meant to them, or any other connected thoughts. The subscriber then flags the event with at least one criteria 208. Criteria for an event may include location, time, activity, participants, or other suitable criteria known in the art. For example, a subscriber could simply flag themselves as a participant in the event. Additional criteria flags may be added 210. If the subscriber had flagged their identity as the first criteria flag, a secondary flag would potentially be the location the event took place. A tertiary flag may include the date in which the event occurred, and so on.

This process would be similar for public users 32. The primary difference being that the public user's identity would not be known by the system 20 during the contribution process. Therefore, the software 24 would be less certain how to sort criteria flags involving identities. To account for this, optionally, the social network software 24 may require public users to provide criteria flags that can be more readily verified, such as dates.

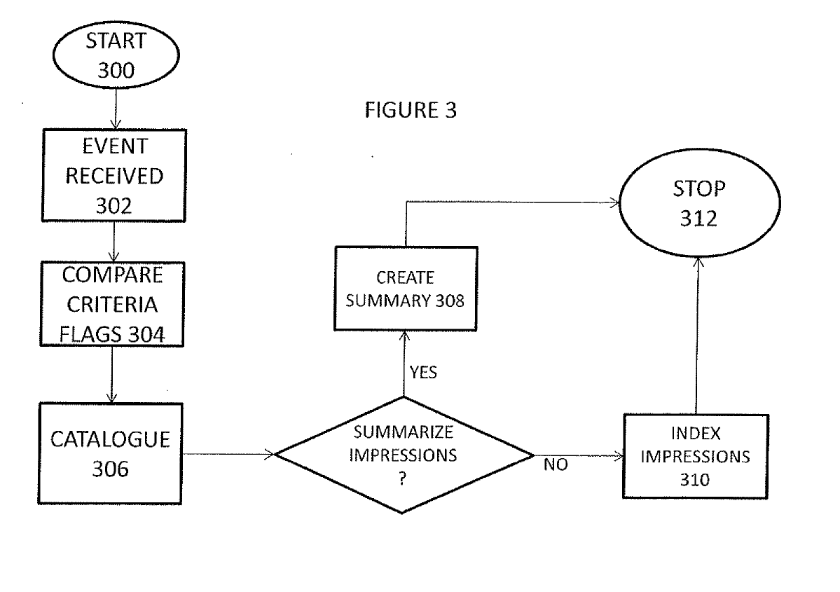

With particular reference to FIG. 3, there is shown a flow chart illustrating the receipt of data on the central database 22. This flowchart picks up where FIG. 2 left off. First, an event is received by the central database 302. Then, within the central database 22, the criteria flags of the submitted event are compared to flags on other submitted events 304. Additionally, the event title, or other information stored within the event could be compared to like information of other submitted events. Based on numerous factors, the submitted event is then catalogued in the database in potentially several fashions 306.

When the system 20 determines that a given event shares enough criteria flags (or title similarity) with another existing event, the events would be merged within the system 20 and considered the same event. Alternatively, a registered subscriber may opt to not allow events submitted to be merged with others. In that case the criteria flags would still be compared against each other and the system 20 would make note of the similar flags in, preparation for system searches conducted at a later date. In yet another method, when the system 20 detects that two events share many of the same criteria flags, the system 20 consults the truth engine 28 to determine what to do with the events. The truth engine 28 would be set such that a particular level of certainty is needed before the system 20 auto corrects outlier criteria flags in the cataloguing process.

Once the system 20 has determined if multiple events are in fact the same event, impressions of that event may be summarized 308. This process would involve the social networking software 24 of the central database 22 reviewing the impressions of merged submitted events and picking out keywords or commonly used phrases and names, and constructing a collated, crowd sourced story, of what occurred at an event, and how the participants felt about that particular event. Alternatively, rather than crowd sourcing an impression, in another preferred embodiment all of the impressions for a given event are logged and indexed 310.

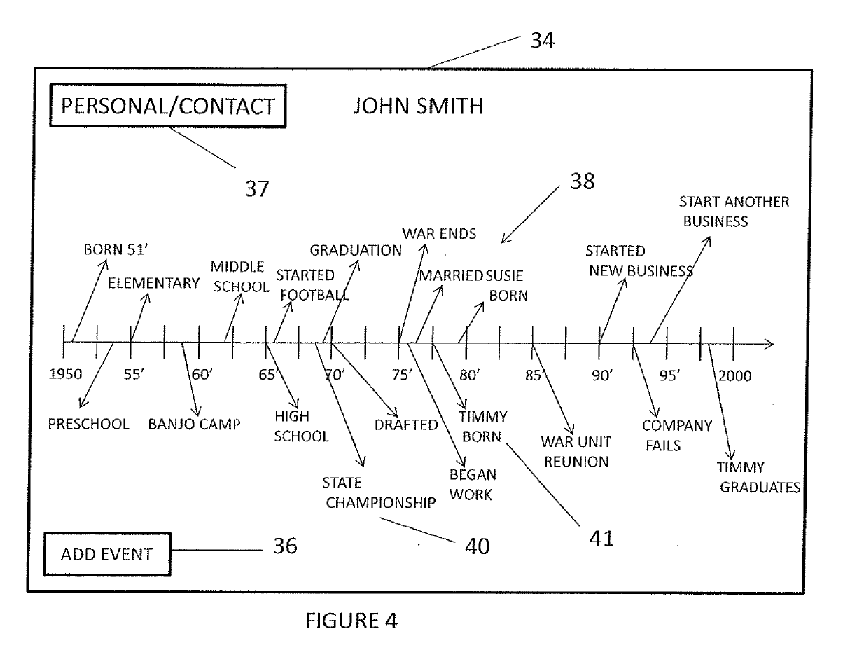

With particular reference to FIG. 4, there is shown an example of a social networking user profile and interface. The user profile and interface 34 would be viewable on an Internet browser. Here, the example is for the registered subscriber 30, “John Smith.” Somewhere on the interface, there would be a clickable “New Event” button 36 allowing a subscriber 30 to add a new event. Additionally, visitors accessing Mr. Smith's user profile would be able to view personal and contact info 37 that Mr. Smith had provided. When clicked it would prompt the subscriber 30 (or public user 32 where appropriate) to provide information regarding the event.

Additionally on the user profile 14 of FIG. 4 is a timeline display 38. The timeline display 38 is an optional aspect of the present invention, and other suitable displays known in the art could be utilized. On the timeline are various events that the fictional, Mr. Smith, or other users have added to the central database 22, wherein Mr. Smith's identity is a criteria flag. Each of these events can be individually selected and viewed in greater detail. Viewable on the timeline display 38, and designated by the numeral 40, is the event for a 1968 high school state football championship 40. This event, along with the others, would include a title and be flagged with Mr. Smith's identity along with the date in which it occurred. For events that were not submitted by a registered user 30, it is conceivable that no identity would be included as a criteria flag.

Mr. Smith is able to set up permissions for other users. These permissions would specify whom and to what degree other registered subscribers 30 could contribute to Mr. Smith's timeline. For some events, like the state championship 40, it is likely that any user could affect the description of the event, because it was likely a highly attended, public event. For other events, such as the birth of Mr. Smith's fictitious son, Timmy, denoted by the numeral 41, Mr. Smith may wish to have stricter controls over who could affect the event. The method of categorizing other subscribed users may work similarly to the “friend” system of Facebook, marketed by Facebook, Inc. of Palo Alto, Calif., or the “circles” system of G+, marketed by Google, Inc. of Mountain View, Calif., or any other suitable system known in the art.

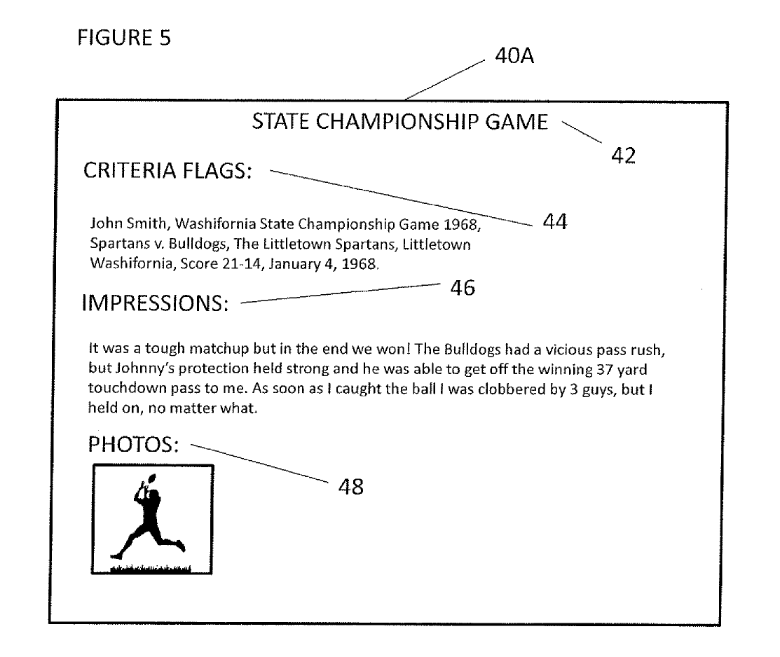

With particular reference to FIG. 5, there is an illustration of a particular event contained within the central database 22. More specifically, FIG. 5 displays the state championship game 40 of FIG. 4 when specifically selected. The selected event page 40A here, would have been contributed entirely by Mr. Smith and has several notable elements. Among these are the title 42, the criteria flags 44, Mr. Smith's impressions of the event 46, and any photographs of the event 48. The sample criteria flags 44 consist of various facts or data points one could use to narrow down the description of the event. Here, the participant, John Smith, is noted, along with other data that helps narrow down exactly what event is being discussed, such as the teams involved, the state in which the game was played, the final score, and the team and town this particular participant was representing. Were this event to be merged with a plurality of others, a roster for each team could be crowd sourced (among other details). The final merged selected event pages 40A would include all of the criteria flags submitted by each user 30, 32. The merging would be possible through use of the truth engine 28. With the given example, the fictional state championship game, were a plurality of users to say that the event occurred in the fictional state of “Washifornia,” but one user stated by criteria flag that the championship was held in Alabama, the truth engine 28 would determine either that there were two different events submitted, or that the lone user was lying to the system.

Also on the selected event page 40A would be the impressions 46 of the contributor. Here, the sample Mr. Smith discusses the memory of heroically catching the game winning pass. Were this impression 46 to be written by another subscriber 30, the text would likely read from a different point of view. Were the impression 46 to be collated with others, there would likely be mentions of details concerning the distance the pass was thrown (here, 37 yards), along with how impressed various other subscribers were with this feat of athleticism. Finally, the selected event page 40A would have uploaded photographs 48. When one event was merged with another, the photographs would be added to an indexed album. With a plurality of events stored in the central database 22, the social networking system 20 could effectively provide a crowd sourced history of a society.

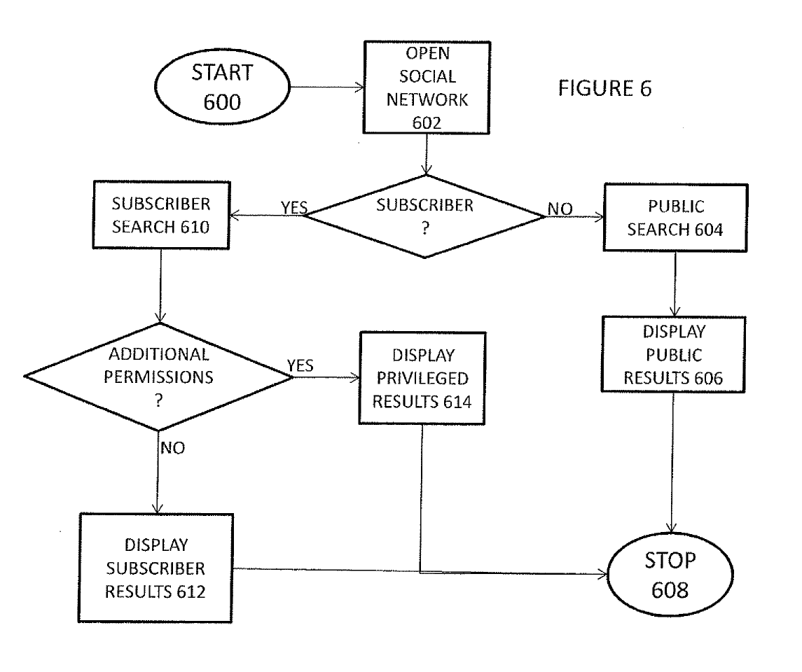

With particular reference to FIG. 6, there is shown a flow chart illustrating the search capabilities of the social networking system 20. First, a user must open up a web browser and go to the URL associated with the social network (602). If the user is a public user 32, that user 32 may search the system 20 using criteria flags anonymously (604). When searching anonymously, the public user 32 would only be able to view a certain top level of the central database 22. The exact amount of data included in this top level would be determined by the operator of the central database 22 in combination with the permissions set by registered subscribers 30. Once the public user 32 has initiated the search, the system 20 will output results 606.

A user that is a registered subscriber 30 can search the system using criteria flags, and potentially additional identity based search features 610. Subscribers would have a greater access to the information on the central database 22 than public users 32. The search results presented to registered subscribers would reflect this 612. Additionally, certain subscribers 30 may have additional search permissions granted from other subscribers 10A. With additional permissions granted, a subscriber's 30 search results would be improved 614.

In the course of use, the social networking system develops large quantities of event data. When compiled, the crowd sourced history of society is searchable, and presents the impressions and feelings of the participants, thereby creating a legacy for relatives, loved ones, and interested parties to view.

While the foregoing detailed description has described several embodiments of the legacy social network in accordance with this invention, it is to be understood that the above description is illustrative only and not limiting of the disclosed invention. Particularly, the social legacy network need not have the exact user interface described. Additionally, while specific levels of user are set forth in the drawing, the legacy social network in accordance with this invention need not be limited by any specific rank or class of users. It will be appreciated that the embodiments discussed above and the virtually infinite embodiments that are not mentioned could easily be within the scope and spirit of this invention. Thus, the invention is to be limited only by the claims as set forth below.

What is claimed is:

1. A method for chronicling personal data over a social network using a database having users comprising:
creating a database for the social network
storing in the database a user profile for the social network system, the user profile being viewable;
entering data into the social network, the data including information about an event in the life of a user and having at least one criteria flag, wherein the at least one criteria flag is a detail pertaining to the event;
cataloging entered data into the database, organized by at least one criteria flag;
searching the database for event data using at least one criteria flag as a search term; and
displaying search results on the social network.

2. The method of claim 1, wherein the user profile is viewable by a social network user interface.

3. The method of claim 1, wherein the social network prompts a user with pre-determined questions directed to eliciting directed data.

4. The method of claim 1, further comprising:
registering subscribers to the social network, wherein subscribers have
greater privileges in searching the database than non-subscribers.

5. The method of claim 1, further comprising: accessing a user profile with a password.

6. The method of claim 1, wherein said data includes a user's impressions of the given life event.

7. The method of claim 6, wherein said cataloguing includes creating a summary of a plurality of user impressions of data that share at least one criteria flag.

8. The method of claim 1, wherein said displaying comprises a timeline.

9. The method of claim 1, wherein said data includes a photograph.

10. The method of claim 1, further comprising: verifying entered data by comparing to other event data sharing at least one criteria flag.

11. A method for chronicling personal data over a social network using a database having users comprising:
creating a database for the social network registering subscribers to the social network;
storing in a database a user profile for subscribers of a social network system, the user profile being viewable;
entering data into the social network, the data including information about an event in the life of the subscriber and having at least two criteria flags, wherein at least one criteria flag is a detail pertaining to the event, and one criteria flag is the identity of the subscriber;
cataloging entered data into the database, organized by criteria flag; and
accessing the user profile.

12. The method of claim 11, wherein the user profile is accessible by a social network user interface.

13. The method of claim 11, wherein said accessing is completed by a member of the general public.

14. The method of claim 11, wherein said accessing may only be accomplished by actors whom have permission from the subscriber.

15. The method of claim 11, wherein said entering may only be accomplished by actors whom have permission from the subscriber.

16. The method of claim 15, wherein the permissions from the subscriber can be granted at multiple levels.

17. The method of claim 11, wherein said data includes a photograph.

18. A computer-readable non-transitory storage media embodying software that is operable when executed by a processor associated with a computer server to:
store a user profile for a user of a social network system, the user profile being viewable;
enter event data into the social network, the data including information about an event in the life of a user and having at least one criteria flag, wherein the at least one criteria flag is a detail pertaining to the event; and
search for event data using at least one criteria flag as a search term.

19. The computer-readable storage media of claim 18, further able to:
verify entered data by comparing to other entered data sharing at least one criteria flag.
